(19) United States
(12) Patent Application Publication
(10) Pub. No.: US 2026/0041277 A1
(43) Pub. Date: Feb. 12, 2026

(54) PORTABLE COOKING ASSEMBLY

(71) Applicant: Jesse W. Solomon, Madison, FL (US)

(72) Inventor: Jesse W. Solomon, Madison, FL (US)

(21) Appl. No.: 18/797,306

(22) Filed: Aug. 7, 2024

(51) Int. Cl. A47J 37/07; B60D 1/06

(52) U.S. Cl. CPC A47J 37/0786; A47J 37/0704; B60D 1/06

(57) ABSTRACT

A portable cooking apparatus is disclosed, including a trailer having at least one grill, at least one hotplate, and at least one deep fryer each positioned on the trailer. At least one storage area is provided to retain foodstuff, a plurality of cooking utensils, and plurality of serving items. A vertical pole including a light extends from the trailer to illuminate the trailer to provide light while preparing and serving the foodstuff.

### TECHNICAL FIELD

The embodiments disclosed herein generally relate to portable cooking assemblies including towable grills and accessories thereof.

### BACKGROUND

Storing and preparing food is an essential part of daily life, as well as an important part of the daily operations of businesses across the world. In recent years, food trucks and portable food trailers have become increasingly popular as fun and convenient ways of transporting and preparing food in non-brick-and-mortar restaurant locations. Food trucks and trailers allow the user to easily store, transport, and prepare food in various location to bring their business to new communities without expanding to new brick-and-mortar locations.

### SUMMARY OF THE INVENTION

This summary is provided to introduce a variety of concepts in a simplified form that is further disclosed in the detailed description of the embodiments. This summary is not intended for determining the scope of the claimed subject matter.

The embodiments provided herein relate to a portable cooking apparatus is disclosed, including a trailer having at least one grill, at least one hotplate, and at least one deep fryer each positioned on the trailer. At least one storage area is provided to retain foodstuff, a plurality of cooking utensils, and plurality of serving items. A vertical pole including a light extends from the trailer to illuminate the trailer to provide light while preparing and serving the foodstuff.

The portable cooking apparatus is towable behind a vehicle to allow the user to move the portable cooking apparatus between preparation, cooking, storage, and serving locations. The may apparatus may include a barbeque grill, hotplate, deep dryer, and auxiliary features. The barbeque, hotplate and deep fryer may be heated by propane, coals, or other known fuel sources. The assembly is mounted to a trailer to allow efficient towing of the cooking assembly to an operating location. The cooking means offer the ability to separately use each of the barbeque, flat top, and deep fryer to simultaneously cook various foods. The mobile cooking assembly includes lighted poles and multiple mounts for propane tanks. Storage compartments, coolers, and similar storage areas are provided as well as a surface for serving or otherwise staging food and related products (i.e., utensils, napkins, plates, condiments, etc.).

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a perspective view of the portable cooking assembly, according to some embodiments;

FIG. 2 illustrates a perspective view of the portable cooking assembly, according to some embodiments;

FIG. 3 illustrates a perspective view of the portable cooking assembly, according to some embodiments;

FIG. 4 illustrates a top plan view of the portable cooking assembly, according to some embodiments; and

FIG. 5 illustrates a perspective view of the trailer hitch and tanks, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to a portable and towable cooking assembly which includes a barbeque grill, hotplate, deep dryer, and auxiliary features. The barbeque, hotplate and deep fryer may be heated by propane, coals, or other known fuel sources. The assembly is mounted to a trailer to allow efficient towing of the cooking assembly to an operating location. The cooking means offer the ability to separately use each of the barbeque, flat top, and deep fryer to simultaneously cook various foods. The mobile cooking assembly includes lighted poles and multiple mounts for propane tanks. Storage compartments, coolers, and similar storage areas are provided as well as a surface for serving or otherwise staging food and related products (i.e., utensils, napkins, plates, condiments, etc.).

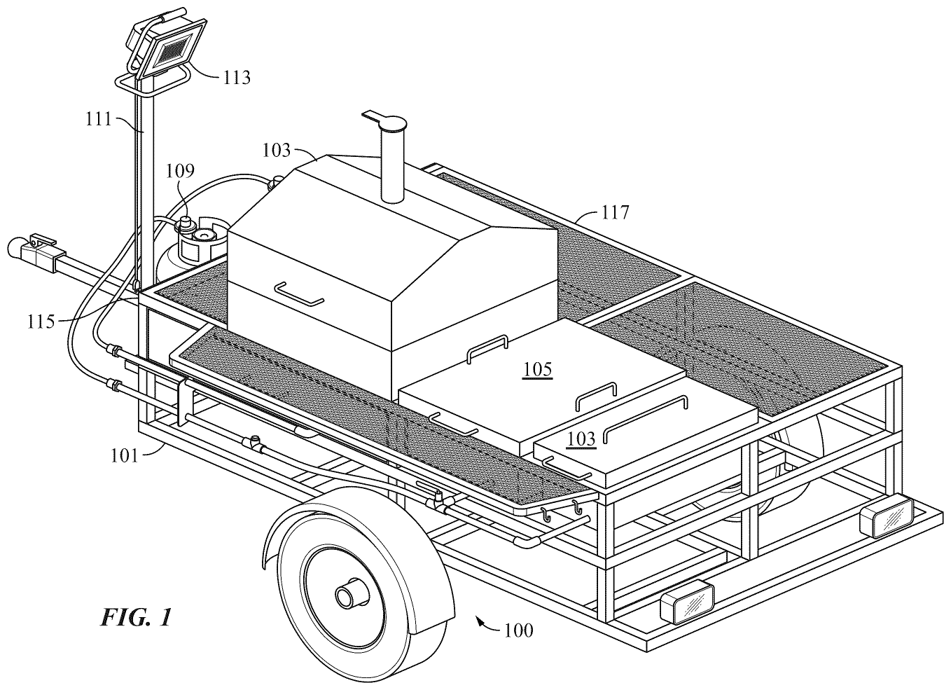

FIGS. 1-4 illustrate the portable cooking assembly 100 which is provided on a trailer 101 capable of being towed behind a vehicle. The portable cooking assembly 100 allows for the simultaneous cooking and preparation of various foods using preparatory areas, and cooking means including at least one grill 103, at least one hotplate (i.e., a flattop) 105, and at least one deep fryer 107. A fuel source 109 may be carried on the trailer 101 to fuel the cooking means. A vertical member 111 includes at least one light 113 to illuminate the portable cooking assembly 100 including the cooking surfaces on the grill 103, hotplate 105 and deep fryer 107. The light 113 may also illuminate the food preparation area(s) 115 such that the user may cook and prepare food in a dark environment.

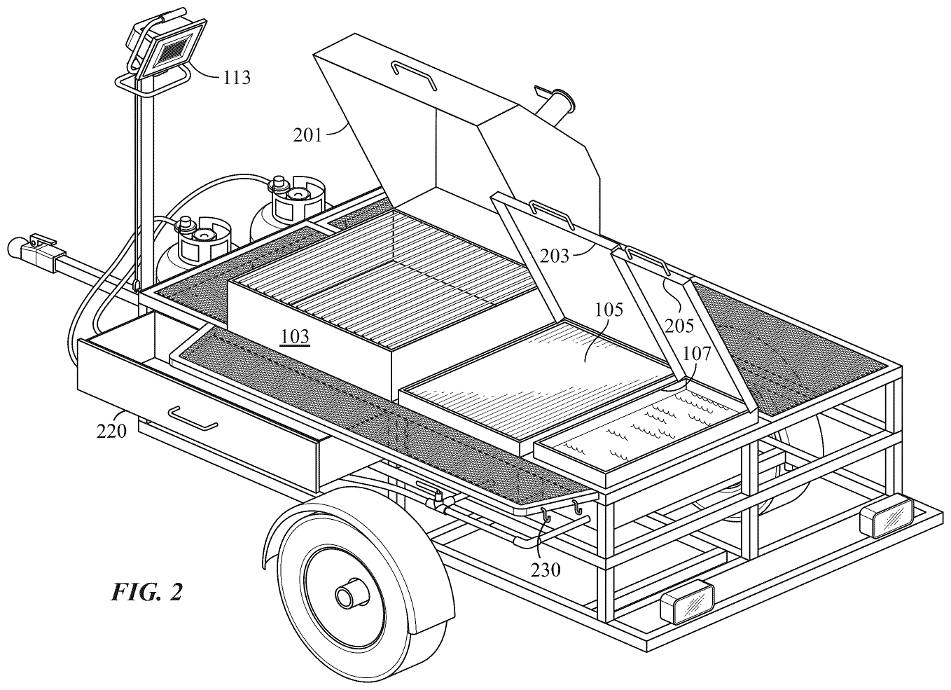

In some embodiments, one or more storage areas 117 may be utilized to store items such as food products, portable fuel sources, utensils, cooking utensils, cooking elements (e.g., pots, pans, etc.) items used for serving the food, and the like. The storage areas 117 may be used to transport items while moving between cooking areas, staging areas, and serving area. Examples of cooking areas may include preparation kitchens, areas where the portable cooking apparatus is used as a means for advertisement the service it provides, areas where the food is cooked, prepared, and served, as well as areas where consumers consume the food product made by the user utilizing the portable cooking apparatus. FIG. 2 illustrates the portable cooking apparatus 100 having lids 201,203,205 which can be used to cover the grill 103, flattop 105 and deep fryer 107.

The cooking means may be readily substituted or modified, making the portable cooking assembly a modular apparatus. Each of the grill 103, hotplate 105, and deep fryer 107 may be fueled by a portable fuel source provided on the trailer 101.

In some embodiments, the portable fuel source is mounted to the trailer 101 using mounts commonly used for propane tanks on barbeques.

In some embodiments, the vertical pole (i.e., the vertical member 111) including a light 113 extends from the trailer to illuminate the trailer to provide light while preparing and serving the foodstuff. The light is positioned on the top end 119 such that the light is positioned to illuminate the trailer 101.

As shown in FIG. 2, a drawer 220 or multiple drawers may be included for storage purposes. The drawer(s) 220 can be used for storing serving utensils, plates, bowls, cooking utensils, eating utensils, etc.

In some embodiments, a drawer 220 may be used as a trash receptable to collect trash from the cooking process or from customers.

In some embodiments, hooks 230 are provided to hang items therefrom. For example, the hooks may be used to hang cooking utensils such as a spatula or spoon.

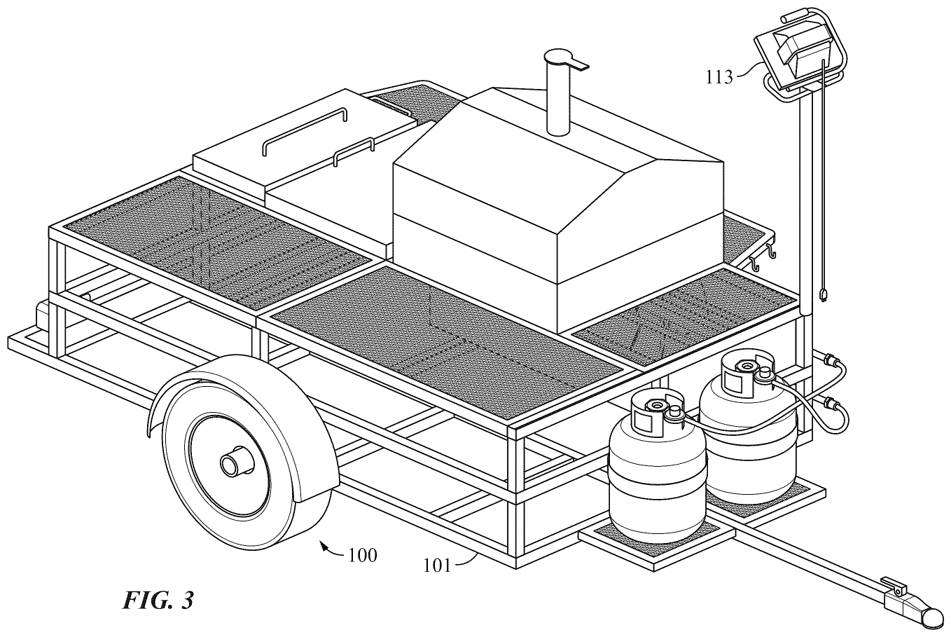

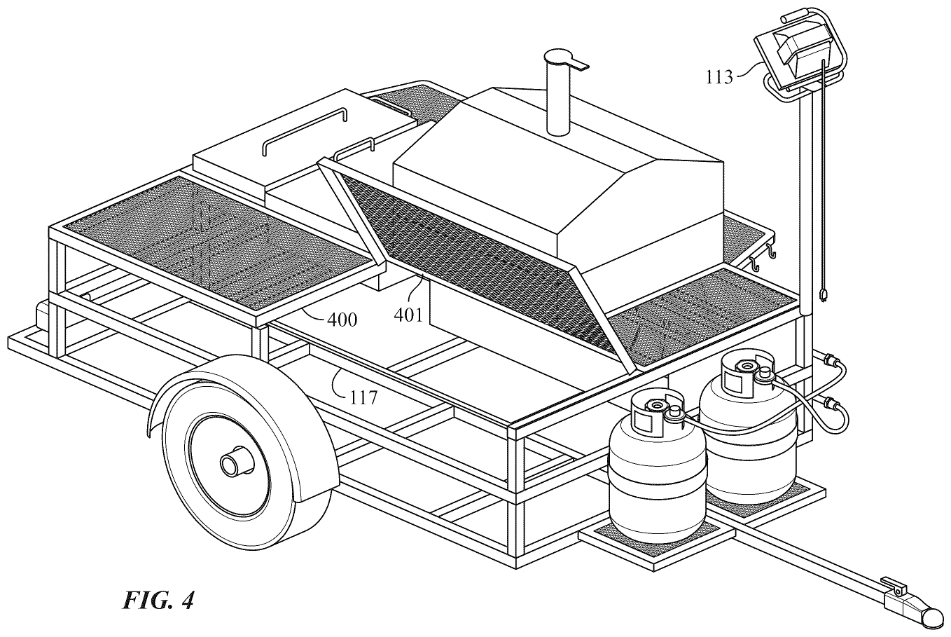

FIG. 3 and FIG. 4 illustrates one or more preparatory lids 400,401 (see FIG. 4) which allow for storage areas 117 to be selectively covered by the user. This allows for stored food to be transported on the trailer between areas where the food is stored, prepared, cooked, and served.

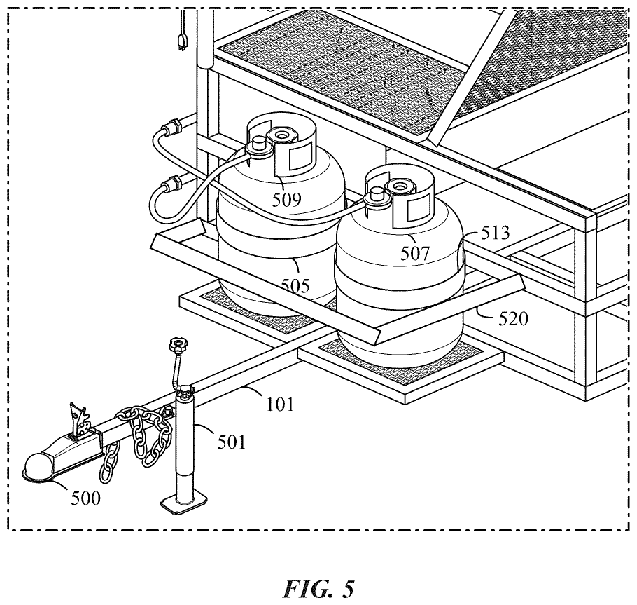

FIG. 5 illustrates the trailer 101 and tow hitch 500. The hitch 500 may be any known configuration which allows for the trailer 101 to be towed behind a vehicle. A portable jack 501 can be raised to maintain level cooking surfaces when the trailer 101 is stationary and in use. Brackets 503,505 secure the tanks 507, 509 which are used as the fuel source while cooking. Straps 513 may secure the tanks in place while being towed by the vehicle to prevent them from falling off of the trailer. Further, a bar 520 may be positioned around the tanks to prevent any unwanted movement of the tanks.

One skilled in the arts will readily understand that while the trailer is a tow-behind trailer as illustrated for exemplary purposes, various other trailer configurations may be implemented including goose-neck trailers, 5^{th} wheel trailers, hitch-mounted attachments, and the like.

In some embodiments, the trailer 101 includes a plurality of auxiliary gas grills, burners, or other cooking mechanisms which allow for items of food to be cooked, boiled, fried, deep-fried, baked, braised, etc. The trailer 101 can be modular such that the user can selectively add, remove, or rearrange cooking elements to their specific needs.

In some embodiments, one or more coolers may be mounted or provided with the trailer. The coolers may be used for food and/or beverage storage to keep items hot or cold.

In some embodiments, one or more tables may be included as an auxiliary food preparation surface or as a surface where prepared food may be placed and consumed. The table(s) may also be used as a surface to place prepared food that is waiting to be picked up by the consumer.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety to the extent allowed by applicable law and regulations. The systems and methods described herein may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

The foregoing is provided for purposes of illustrating, explaining, and describing embodiments of this disclosure. Modifications and adaptations to these embodiments will be apparent to those skilled in the art and may be made without departing from the scope or spirit of this disclosure.

As used herein and in the appended claims, the singular forms “a”, “an”, and “the” include plural referents unless the context clearly dictates otherwise.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic intervening entities) and the indirect coupling of two entities (with one or more non-negligible intervening entities). Where entities are shown as being directly coupled together or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described herein. A variety of modifications and variations are possible in light of the above teachings without departing from the following claims.

What is claimed is:

1. A portable cooking apparatus, comprising:
a trailer including at least one grill, at least one hotplate, and at least one deep fryer each positioned on the trailer;
at least one storage area to retain foodstuff, a plurality of cooking utensils, and plurality of serving items;
a vertical member including a light to illuminate the trailer to provide light while preparing and serving the foodstuff.

2. The apparatus of claim 1, wherein the trailer is towable.

3. The apparatus of claim 2, wherein the trailer includes a tow hitch to permit the trailer to be towed behind a vehicle.

4. The apparatus of claim 1, wherein the light is positioned at the top end of the vertical member.

5. The apparatus of claim 1, the one or more lids are positioned to enclose and open the at least one grill, the at least one hotplate, and the at least one deep fryer.

6. The apparatus of claim 1, further comprising at least one fuel source to provide fuel to the at least one grill, the at least one hotplate, and the at least one deep fryer.

7. The apparatus of claim 6, wherein the at least one fuel source is a propane tank.

8. The apparatus of claim 6, wherein the at least one fuel source is an organic fuel source.

9. The apparatus of claim 6, wherein the at least one fuel source is an electric fuel source.

10. A portable cooking apparatus, comprising:
a trailer including at least one grill, at least one hotplate, and at least one deep fryer each positioned on the trailer;
at least one storage area to retain foodstuff, a plurality of cooking utensils, and plurality of serving items;
a vertical member including a light to illuminate the trailer to provide light while preparing and serving the foodstuff; and
at least one fuel source to provide fuel to the least one grill, the at least one hotplate, and the at least one deep fryer.

11. The apparatus of claim 10, wherein the trailer is towable.

12. The apparatus of claim 11, wherein the trailer includes a tow hitch to permit the trailer to be towed behind a vehicle.

13. The apparatus of claim 12, wherein the light is positioned at the top end of the vertical member.

14. The apparatus of claim 13, the one or more lids are positioned to enclose and open the at least one grill, the at least one hotplate, and the at least one deep fryer.

15. The apparatus of claim 14, further comprising at least one fuel source to provide fuel to the at least one grill, the at least one hotplate, and the at least one deep fryer.

16. The apparatus of claim 15, further wherein the at least one storage area is configured to store a plurality items.

17. The apparatus of claim 16, wherein the plurality of items include a plurality of utensils, a plurality of serving items, and a plurality of food preparation items.
